(19) United States
(12) Patent Application Publication
(10) Pub. No.: US 2025/0232694 A1
(43) Pub. Date: Jul. 17, 2025

(54) RETAIL INFORMATION DISPLAY SYSTEM

(71) Applicant: SageNet LLC, Reston, VA (US)

(72) Inventor: Dawei CAI, Marietta, GA (US)

(21) Appl. No.: 19/018,493

(22) Filed: Jan. 13, 2025

Related U.S. Application Data
(60) Provisional application No. 63/620,823, filed on Jan. 14, 2024.

(51) Int. Cl. G09F 3/20

(52) U.S. Cl. CPC G09F 3/208

(57) ABSTRACT

A method and system for displaying tag content on a shelf-edge digital display is provided. In an embodiment, a retail information server is configured to receive tag provisioning information from a mobile device, retrieve retail information associated with one or more goods based on the tag provisioning information, and generate a digital signal based on the tag provisioning information and the retail information. A media player is configured to receive the digital signal and render visual tag content including the retrieved retail information. A digital display device positioned on a product display shelf in a retail environment and configured to receive the rendered visual tag content and to display the visual tag content at a location on the digital display device corresponding to a location of the associated one or more goods on the product display shelf.

### CROSS-REFERENCE TO RELATED APPLICATION AND CLAIM OF PRIORITY

This application claims the benefit of priority of U.S. Provisional Application No. 63/620,823 filed Jan. 14, 2024, the complete disclosure of which is incorporated herein by reference.

### TECHNICAL FIELD

This technology generally relates to displaying retail information on a store shelf and in some embodiments relates to a system capable of receiving an input, generating retail information dynamically, and displaying the retail information at the edge of a store shelf based on the input.

### BACKGROUND

Product data, including price, and promotion information at brick-and-mortar retail store locations are generally updated manually. In retail establishments, the in-store systems, such as point-of-sale (POS) systems, receive updates on pricing and promotions from a central retailer system. When updates are received, paper or plastic price labels and signs can be created or modified (e.g., erasing and rewriting information on the signs) to reflect the pricing and promotion updates. Store staff are tasked with the responsibility of replacing or modifying the previous labels and signs with new, updated labels and signs. This is a labor-intensive process that is time-consuming, expensive to implement, and prone to errors.

Attempts have been made to automate the updating process of in-store systems with pricing and promotional details. However, these systems have faced challenges and yielded limited success, primarily due to the significant investments required in equipment, proprietary communication technologies, and other expensive infrastructure. As a result, very few, if any, of these automated systems have seen widespread adoption. Furthermore, the identification of missing, out-of-stock, or incorrectly placed products on store shelves has relied on manual visual assessments of product placement and inventory.

### SUMMARY

This Summary is provided to introduce a selection of representative concepts in a simplified form, which representative concepts are further described below in the Detailed Description. This Summary is not intended to identify key features or essential features of the claimed subject matter, nor is it or the objects and benefits described herein intended to be used to limit the scope of the claimed subject matter.

The retail information display system according to some embodiments of this disclosure provides flexibility and efficiency by allowing retail information to be displayed dynamically. In some embodiments, the system provides real-time updates, dynamic content (including pricing), customization and targeting (including specialized size or configuration of price labels and dynamic visual notifications to aid in the identification of item location when fulfilling orders, restocking or reorganizing shelves, etc.), remote management, reduced environmental impact, adaptability, interactivity, and/or integration with data sources to provide up-to-date information.

In some embodiments described herein, retail information can be provided remotely and transmitted to one or more digital displays respectively mounted on one or more edges of one or more shelves. The retail information display system of some embodiments of the disclosure can provide retail stores with the ability to dynamically align retail information with items provided in various locations on the shelf. The digital display in some embodiments described herein can also be used to visually indicate the location of a specific product on a shelf.

In an aspect of the present disclosure, a system for displaying tag content is provided that includes a retail information server, a media player, and a digital display device. The retail information server is configured to receive tag provisioning information from a mobile device, retrieve retail information associated with one or more goods based on the tag provisioning information, generate a digital signal based on the tag provisioning information and the retail information, and transmit the digital signal. The media player is configured to receive the digital signal and render, based on the digital signal, visual tag content including the retail information. The digital displayer device is positioned on a product display shelf in a retail environment and configured to receive the rendered visual tag content from the media player and display the rendered visual tag content at a location on the digital display device corresponding to a location of the associated one or more goods on the product display shelf.

In another aspect of the present disclosure, a method for displaying tag content is provided. A retail information server receives tag provisioning information from a mobile device, retrieves retail information associated with one or more goods based on the tag provisioning information, and generates a digital signal based on the tag provisioning information and the retail information. A media player receives the digital signal and renders visual tag content including the retail information based on the digital signal. A digital display positioned on a product display shelf in a retail environment receives the rendered visual tag content, and displays the visual tag content at a location on the digital display device corresponding to a location of the associated one or more goods on the product display shelf.

In still another aspect of the present disclosure, a computer program product is provided that includes one or more computer processors and one or more computer readable storage media containing non-transitory computer-executable instructions executable by the one or more computer processors to: receive tag provisioning information from a mobile device; retrieve retail information associated with one or more goods based on the tag provisioning information; generate a digital signal based on the tag provisioning information and the retail information; render visual tag content including the retail information based on the digital signal; receive the rendered visual tag content at a digital display device positioned on a product display shelf in a retail environment; and display the visual tag content at a location on the digital display device corresponding to a location of the associated one or more goods on the product display shelf.

It should be understood that the above-described aspects and embodiments described herein may be combined with one another in any combination and may be modified to include, for example, one or more embodiments described herein, including in the detailed description below and in the accompanying drawings.

The above and still further objects, features and advantages of certain aspects and embodiments will become apparent upon consideration of the following detailed description of exemplary embodiments, particularly when taken in conjunction with the accompanying drawings, wherein like reference numerals in the various figures are utilized to designate like components.

### BRIEF DESCRIPTION OF THE DRAWINGS

The drawings referenced herein form a part of the specification and are incorporated herein by reference. Features shown in the drawings are meant as illustrative of only some embodiments, and not of all embodiments, unless otherwise explicitly indicated.

FIG. 1 illustrates an exemplary embodiment including first (upper) and second (lower) digital displays mounted on shelf edges of wall-mounted shelves.

FIG. 2 illustrates a diagram of a shelf-edge system according to an exemplary embodiment of the present disclosure.

FIG. 3 illustrates a block diagram of a media player of the shelf-edge system according to an exemplary embodiment of the present disclosure.

FIG. 4 illustrates a block diagram of a tag application provided on a media player of the shelf-edge system according to an exemplary embodiment of the present disclosure.

FIG. 5 illustrates a block diagram of a retail information server of the shelf-edge system according to an exemplary embodiment of the present disclosure.

FIG. 6 illustrates a block diagram of a digital display of the shelf-edge system according to an exemplary embodiment of the present disclosure.

FIG. 7 illustrates a block diagram of a mobile device of the shelf-edge system according to an exemplary embodiment of the present disclosure.

FIG. 8 illustrates a signal diagram of an initialization method of the shelf-edge system according to an exemplary embodiment of the present disclosure.

FIG. 9 illustrates a signal diagram of a tag content displaying method of the shelf-edge system according to an exemplary embodiment of the present disclosure.

FIGS. 10-12 illustrate tag content according to exemplary embodiments of the present disclosure.

FIG. 13 illustrates an exemplary vertical slice of retail information according to an exemplary embodiment of the present disclosure.

FIG. 14 illustrates an exemplary horizontal slice of retail information according to an exemplary embodiment of the present disclosure.

FIGS. 15-17 illustrate exemplary user interface provisioning screens within the tag provisioning application launched on the mobile device of the shelf-edge system according to an exemplary embodiment of the present disclosure.

FIGS. 18-20 illustrate exemplary user interfaces for controlling the display of information, including placement of tag information, on digital display units according to an exemplary embodiment of the present disclosure.

### DETAILED DESCRIPTION

The various embodiments are described in detail with reference to the accompanying drawings. Whenever possible, the same reference numbers are used throughout the drawings to refer to the same or like parts. References made to particular examples, details, and representative materials, methods, and implementations are for illustrative purposes only, and thus do not, and are not intended to, limit the scope of the various embodiments of the claims.

The following description with reference to the accompanying figures is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize various changes and modifications of the various embodiments described herein. It will be readily understood that the components and features of the exemplary embodiments, as generally described herein and illustrated in the Figures, may be arranged and designed in a wide variety of different configurations. Thus, the following detailed description of the embodiments of the methods, devices, assemblies, apparatus, systems, etc. of the exemplary embodiments, as presented in the Figures, is not intended to limit the scope of the embodiments, as claimed, but is merely representative of selected embodiments.

The illustrated embodiments will be best understood by reference to the drawings, wherein like parts are designated by like numerals throughout. Whenever possible, the same reference numbers are used throughout the drawings to refer to the same or like parts. References made to particular examples, details, and representative materials, methods, and implementations are for illustrative purposes only. The following description is intended only by way of example, and illustrates certain selected embodiments of methods, devices, assemblies, apparatus, systems, etc. that are consistent with the embodiments as claimed herein.

The following description with reference to the accompanying figures is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for brevity.

It is to be understood that the singular forms “a,” “an,” and “the” include plural referents unless the context clearly dictates otherwise.

As used herein, the term “and/or” means either or both (or any combination or all of the terms or expressed referred to. For example, “A, B, and/or C” encompasses A alone, B alone, C alone, A and B, A and C, B and C, and A, B, and C.).

The terms “have”, “may have”, “can have,” “include”, “may include”, “can include”, “comprise”, and the like used herein indicate the existence of a corresponding feature (e.g., a number, a function, an operation, or an element) and do not exclude the existence of an additional feature.

The terms “first”, “second”, and the like used herein may modify various elements regardless of the order and/or priority thereof, and are used only for distinguishing one element from another element, without limiting the elements, unless the context clearly indicates otherwise. For example, “a first element” and “a second element” may indicate different elements regardless of the order or priority.

It will be understood that when a certain element (e.g., a first element) is referred to as being “operatively or communicatively coupled with/to” or “connected to” another element (e.g., a second element), the certain element may be coupled to the other element directly or via another element (e.g., a third element). However, when a certain element (e.g., a first element) is referred to as being “directly coupled” or “directly connected” to another element (e.g., a second element), there may be no intervening element (e.g., a third element) connecting the element and the other element.

The term “configured to” or “set to” as used herein may be interchangeably used with the terms, for example, “suitable for”, “having the capacity to”, “designed to”, “adapted to”, “made to”, or “capable of”. The term “configured to” or “set to” may not necessarily have the meaning of “specifically designed to”. In some cases, the term “device configured to” may indicate that the device “may perform” together with other devices or components.

The word “exemplary” is used herein to mean “serving as an example, instance, or illustration.” Any implementation described herein as “exemplary” is not necessarily to be construed as preferred or advantageous over other implementations.

Reference throughout this specification to “a select embodiment,” “one embodiment,” “an exemplary embodiment,” “exemplary embodiments,” “an embodiment,” or “embodiments” means that a particular feature, structure, or characteristic described in connection with the embodiment(s) is included in at least one embodiment. Thus, appearances of the phrases “in a select embodiment,” “in one embodiment,” “in an exemplary embodiment,” “in exemplary embodiments,” “in an embodiment,” or “in embodiments” in various places throughout this specification are not necessarily referring to the same embodiment(s) or only a single embodiment. The embodiments may be, for example, combined with one another in various combinations and modified to include features of one another.

An improved system for displaying retail information can include a digital display mounted on a shelf edge in a retail environment. In some embodiments, more than one digital display is mounted to the same edge, for example, in side-by-side arrangement, in a retail environment. In some embodiments, the digital display is configured to dynamically display retail information. A location in which the retail information is to be displayed on the digital display, e.g., on the viewing area or screen of the digital display, can be identified in a tag application and remotely communicated to the digital display.

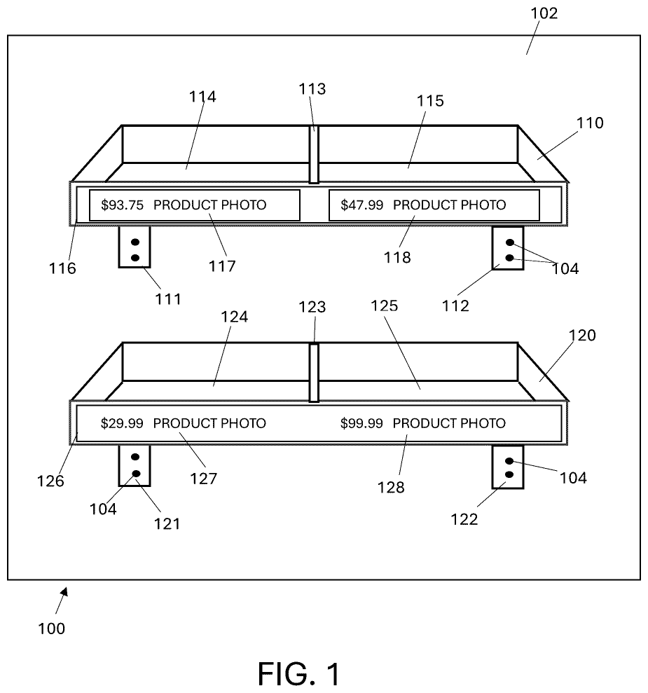

FIG. 1 is a front view of a shelf assembly with mounted displays, generally designated by reference numeral 100. The shelf assembly with mounted displays 100 includes an upper first shelf 110 and a lower second shelf 120. The upper first shelf 110 is mounted to a wall support or vertical display member 102 using bottom brackets 111 and 112. Likewise, the lower second shelf 120 is mounted to the wall support or vertical display member 102 using bottom brackets 121 and 122. Fasteners 104 such as bolts, screws, nails, etc., can be used to mount the brackets 111, 112, 121, and 122 to the wall support or vertical display member 102.

The first shelf 110 and the second shelf 120 may each be configured to hold consumer goods and products of the type found in a brick-and-mortar retail establishment, for allowing display, consumer selection and removal, and purchase of the goods and products. In the illustrated embodiment, the first shelf 110 and the second shelf 120 include a first center divider 113 and a second center divider 123, respectively. The first center divider 113 divides the first shelf 110 into a first upper compartment 114 and an adjacent second upper compartment 115. The second center divider 123 divides the second shelf 120 into a first lower compartment 124 and a second lower compartment 125. It should be understood that the first and second shelves 110 and 120 may include more or no dividers and more or fewer compartments.

A first digital display unit or device 116 is mounted on a front face or edge of the upper first shelf 110, and a second digital display unit or device 126 is mounted on a front face or edge of the lower second shelf 120. It should be understood that any suitable fastener (e.g., screw, bolt, rivet, bracket, etc.) or adhesive or other mounting technique may be used for mounting the first and second digital display units or devices 116 and 126. The first digital display unit or device 116 is shown displaying a first slice 117 of product information and a second slice 118 of product information relevant or corresponding to products to be stored or displayed in the first upper compartment 114 and the second upper compartment 115. Just as the upper first shelf 110 may be divided into more than two compartments, the digital display unit or device 116 can display additional slices of product information, with each slice of product information corresponding in location and content to the product of the associated compartment immediately behind the slice.

Similarly, the second digital display unit or device 126 is shown displaying a first slice 127 of product information and a second slice 128 of product information relevant or corresponding to products to be stored or displayed in the first lower compartment 124 and the second lower compartment 125. Just as the lower second shelf 120 may be divided into more than two compartments, the second digital display unit or device 126 can display additional slices of product information, with each slice of product information corresponding in location and content to the product of the associated compartment immediately behind the slice.

While FIG. 1 illustrates the upper first shelf 110 equipped with the single first digital display unit or device 116, the present disclosure also includes the mounting of multiple digital display units or devices in side-by-side or other relation to one another on the same front face of the upper first shelf 110. The same applies to the lower second shelf 120 and the second digital display unit or device 126.

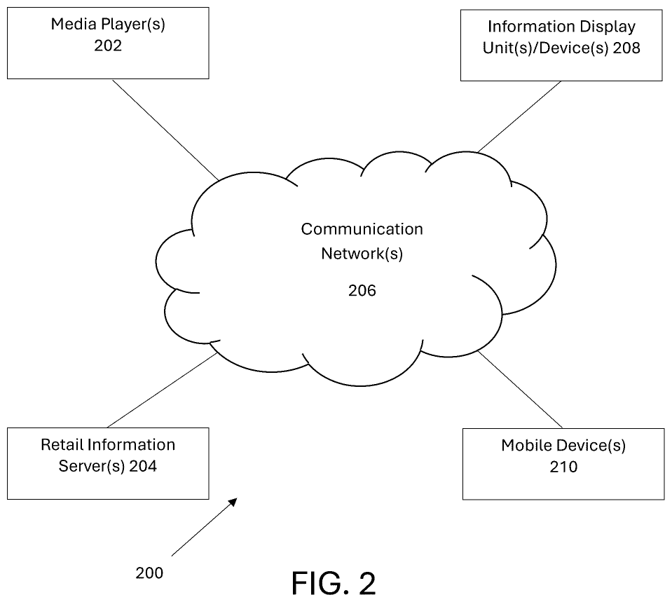

FIG. 2 illustrates a diagram of a system according to an exemplary embodiment of the present disclosure, with the system generally designated by reference numeral 200.

Referring to FIG. 2, the system 200 includes one or more media players 202, one or more retail information servers 204, one or more communication networks 206, one or more shelf-mounted digital displays 208, and one or more mobile devices 210. Sometimes the media players 202, the servers 204, the communication networks 206, the digital displays 208, and the mobile devices 210 are referred to herein in the singular for the purpose of brevity; however, it should be understood that each may comprises “one or more” unless the context clearly dictates otherwise.

In some embodiments, the media player 202 is a software-executing or application-executing device configured to decode and render media content that includes retail information to be displayed on the one or more shelf-mounted digital displays 208. In some embodiments, media player 202 is configured to create, for example, visual tag content comprising visualizations including static or animated graphics corresponding to the retail information and tag provisioning information using a tag application.

The retail information used in the tag application can include, for example, information associated with one or more products available within the retail environment, a quantity of products available within the retail environment, and/or other relevant information. For example, retail information can include information regarding one or more of product identifying information (e.g., names, Stock Keeping Unit (SKU) identifiers), descriptive information (e.g., a brief description of each item, features, key characteristics, etc.), product categorization (e.g., classification or organizational information regarding locations within the retail environment), quantities (e.g., an identification of a quantity of each product available at the retail environment, in transit, on order, including variations if applicable (e.g., sizes, colors, models, etc.)), location within the retail environment (e.g., aisle numbers, shelf identification information, etc.), pricing (e.g., retail price, discounts, promotions, or special pricing for each item), supplier information (e.g., supplier identity, address, shipping information), stock levels (e.g., information regarding levels of available stock items, including designations of in-stock, low stock, out of stock, etc.), inventory management information (e.g., information regarding how often inventory is updated or how real-time the system is), technology integration (e.g., information to allow technology to be used for inventory tracking, such as bar codes, QR codes, RFID cods, point-of-sale integration), and/or unique selling points (e.g., unique or standout products, special features, limited editions, or exclusivity).

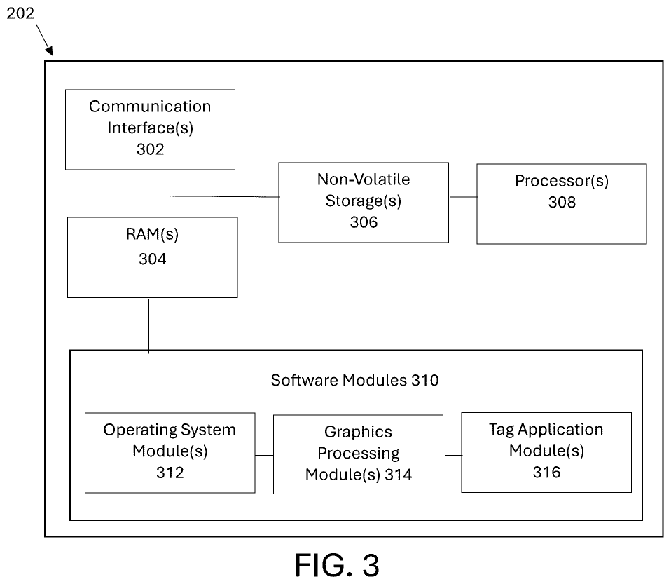

As illustrated in the block diagram of FIG. 3, in an embodiment the media player 202 (of FIG. 2) comprises a computing device including one or more wired and/or wireless communication interfaces 302, one or more random access memory (RAM) modules 304, one or more non-volatile disk storages 306, one or more processors 308, and one or more software modules 310. In some embodiments, the software modules 310 include one or more operating systems or modules 312, one or more graphics processing modules 314, and one or more tag application modules (also referred to herein as tag applications) 316. It should be understood that while each of the components of FIG. 3 are described in the singular, each may be present in the plural, and vice versa. Further, one or more of the components 302, 304, 306, 308, 310, 312, 314, and 316 of the media player 202 may be remotely or separately located from one another and from other components described herein. Further, one or more of the components 302, 304, 306, 308, 310, 312, 314, and 316 of the media player 202 may be combined with one another.

In some embodiments, the media player 202 is configured to run the tag application module 316 and provide a digital visual signal generated using the graphics processing module 314. In some embodiments, the digital visual signal includes information corresponding to tag content to be displayed on the information display unit 208.

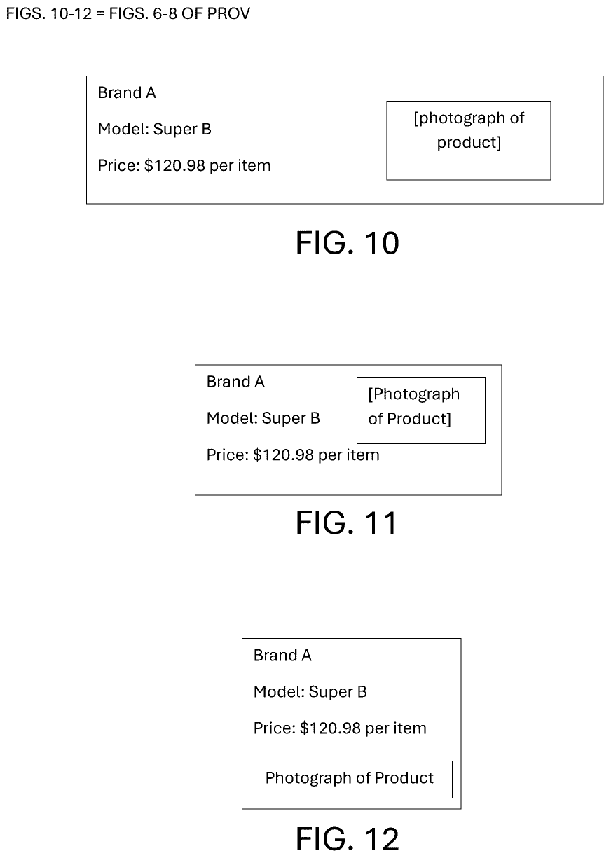

In some embodiments, tag content is any visual indicator that includes retail information corresponding to a single inventory item that is, or multiple inventory items that are, provided on the shelf 104. In some embodiments, tag content comprises one or more of pricing information and/or quantity, such as quantity situated on the associated shelf or quantity within the retail environment. Various non-limiting examples of tag content are illustrated in FIGS. 10-12.

In some embodiments, the digital visual signal is used to communicate tag information from the one or more media players 202 to the one or more information display units 208. The tag application module 316 (and other modules 312 and 314) can be loaded onto the one or more media players 202 through a suitable communication means, including, for example, WIFI, Ethernet data transfer, direct media deposit onto the player, etc., and other communication means described herein.

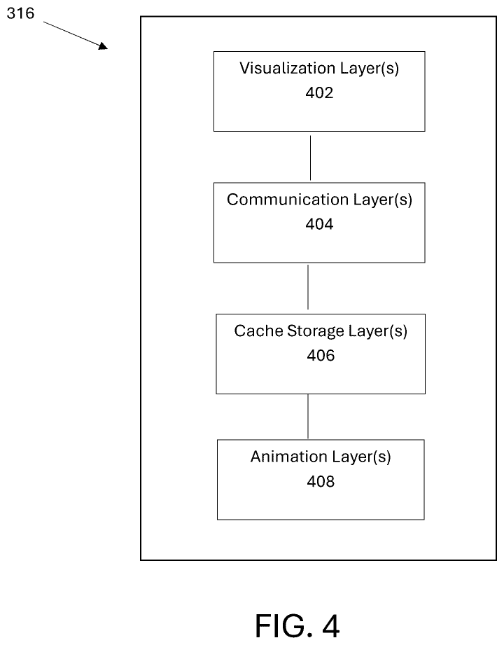

In one or more embodiments, the tag application module 316 is configured to run on one or more of the media players 202. FIG. 4 is a block diagram illustrating the tag application module 316 is further detailed according to some embodiments. As illustrated in FIG. 4, the tag application module 316 can include one or more visualization layers 402, one or more communication layers 404, one or more cache storage layers 406, and one or more animation layers 408. Alternatively, the tag application module 316 of some embodiments may include a combination comprising any two or more, but less than all, of the illustrated layers 402, 404, 406, and/or 408. In some embodiments, the tag application module 316 may include additional layers not shown in FIG. 4.

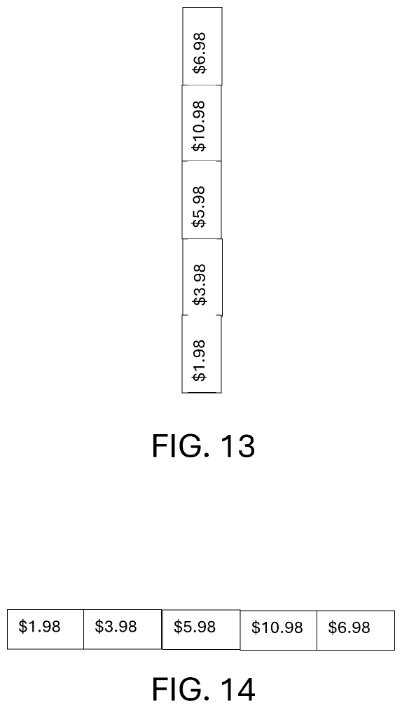

Turning to the specific layers illustrated in FIG. 4, in some embodiments, the visualization layer 402 of the tag application 316 is configured to draw basic elements of the tags onto a canvas and define positions as well as data in the form of images and text for each tag. In some embodiments, the virtualization layer 402 is configured to define the slices of screen data for display in, for example, a vertical (see FIG. 13) or horizontal (see FIG. 14) format.

In some embodiments, input from the tag provisioning application 712 is provided to the media player 202, which generates a single resolution rendering that will include all tags in a vertical format, a horizontal format, or a vertical and horizontal format or matrix. The media player 202 renders a visual signal that includes tag content in the form of slices or slivers, with each of the slices or slivers corresponding to a screen of the arrangement of visual screen of the information display units 208. For example and without limitation, if the screens of the information display units 208 are arranged in a 2×3 matrix, the media player 202 may emit a digital signal comprising six slices each representing one of the screen of the 2×3 matrix. The media player 202 may output the tag information via a single signal using the communication network 206 described herein (e.g., using HDMI, USB, etc.) to the information display units 208. In an embodiment in which the information display units 208 are arranged serially or “daisy-chained,” the digital signal is sent to the first information display unit in the series, then consecutively to each following information display unit in the series or chain. In exemplary embodiments, the arrangement of the slices in defined in advance using the tag provisioning application 712 of the mobile device 210.

In some embodiments, the communication layer 404 of the tag application 316 is configured to establish an optionally encrypted communication channel between the tag application module(s) 316 and the retail information server 204.

For example, in some embodiments the communication channel is a single direction (polling) from the tag application 316 requesting updates. In other embodiments, the communication channel is a bidirectional channel that both pulls and pushes data between the tag application 316 launched in or by the media player 202 and the retail information server 204.

In some embodiments, the cache storage layer 406 of the tag application 316 is configured to persist the data collected from the retail information server 204 and store the collected data locally on the media player 202. For example, in some embodiments the tag application 316 launched on the media player 202 is configured to retrieve information or content from the retail information server 204 over the communication network 206 and store the retrieved information locally at the media player 202, e.g., at the cache storage layer(s) 406. Such operation allows for uninterrupted function in the event of a communication outage. For example, in an exemplary embodiment, the last known valid retail information (e.g., pricing, description, stock details, etc.) transferred from the retail information server 204 to the media player 202 will be stored at the media player 202 and, in the event of interruption, transmitted to the digital display units 208. If needed in the event that the media player 202 is restarted without a communication channel or is unable to connect to the retail information server 204, the tag application 316 will still be able to display the last known data set received by the media player 202 despite the interruption of communication between the media player 202 and the retail information server 204, e.g., in the case of a power outage.

In some embodiments, the animation layer 408 of the tag application 316 is configured to process timed or event-driven visual changes. The timed or event-driven visual changes for display on the digital display devices 208 can include, for example, tags that cycle through information like price, descriptions, stock status, etc. For example, the timed visual change may cause the visual display on the digital display devices 208 to consecutively display pricing, product description, stock (or shelf) inventory, and/or other product information for viewing by the consumer. In some embodiments, the animation layer 408 is also capable of creating a flash or rapidly changing visuals to draw attention to the tag in the event of a communication trigger to start such an event for a period of time.

In some embodiments, the retail information server 204 is configured to manage and store the retail information of a retailer corresponding to the retail environment.

In an embodiment, retail information server 204 can comprise one or more elements configured to facilitate communications with the tag application module 316 that is running on the media player 202 and with a tag provisioning application (not shown) running on one or more of the mobile devices 210 that is/are configured to receive information to provision the tag application 316 associated with the media player 202. The tag provisioning application running on the mobile device(s) 210 may be, for example, a webapp accessed via a browser or browser wrapper or a native application code. In some embodiments, retail information server 204 is configured to be a source location to store persistent data in the event of reboots of the tag application module 316 or the media player 202 or digital display replacements.

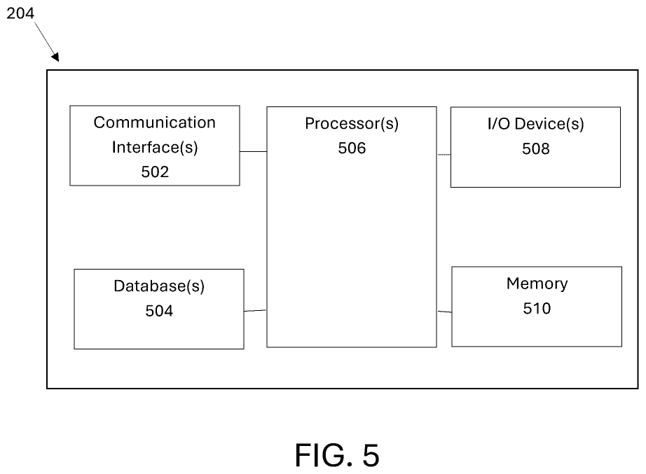

As illustrated in FIG. 5, in some embodiments, the retail information server 204 includes one or more wired and/or wireless communication interfaces 502, one or more databases 504 configured to store information including retail information, one or more processors 506 in communication with the communication interface 502 and the database 504, and one or more input/output (I/O) devices 508 and memory 510 also in communication with and operatively associated with the one or more processors 506.

In some embodiments, the retail information server 204 includes cloud services of different application layers configured to connect to a database to persistently store data that is provided from the media player 202 and displayed on the information display device 208. One or more of the following can be stored, accessed, and retrieved from the retail information server 204: user information, encrypted passwords, records of media player identities and corresponding store information, inventory item and corresponding aisle/shelf information, geographical location of the media player 202, and other associated information.

In some embodiments, the retail information server 204 is remotely located (e.g., cloud based or with a host) from the brick-and-mortar retail location. In some embodiments, for example those in which the retail information server 204 is remote, computing and processing is performed at the retailer information server 204, e.g., at the cloud or host. In other embodiments, the retail information server 204 is in the physical possession and/or control of the retailer, e.g., at the retail location. In some embodiments, for example those in which the retail information server 204 is in the possession of the retailer, backend computing and processing functions are performed remotely, e.g., processing is performed on a cloud or a backend service engine. For the purposes of this disclosure, retail information server 204 is considered to encompass embodiments in which computing and processing are conducted locally on the retail information server 204 and embodiments in which backend services are conducted remotely, such as on a cloud platform or backend service engine, unless the context clearly dictates otherwise.

Communication with the retail information server 204 (e.g., between backend services and the server 204 if separate from one another) can be bidirectional or unidirectional to any application, for example, with valid encryption keys and permissions to allow real time visual queues to be triggered for a defined period of time. In addition, in some embodiments, communication, e.g., with the retail information server 204, can be bidirectional or unidirectional to external sources of a customer or vendor to fetch or push data about items to be represented via the tag application 316. Tag data displayed on the digital displays 208 can be constantly or periodically updated, for example, to reflect the latest price, inventory status, etc.

In some embodiments, the processing or backend services (at or remote relative to the physical location of the retail information server 204) are configured to exchange data with the tag application module(s) 316 of the media player 202 using a push method, a pull method, or a combination of push and pull methods (i.e. bidirectional). For example, in an embodiment involving a push method, the retail information server 204 is configured to push data to the tag application module(s) 316. The push method may involve differentials (or a differential data set) of data since the previous push event. Alternatively, the push method may involve a full update or full data transfer, including data pushed in the previous push event. In some embodiments the communication channel is a single pulling direction from the tag application 316 requesting updates. In some embodiments, in the event of a pull scenario, the tag application 316 will periodically query the retail information server 204 for either differential updates since the last pull event or a complete pull of data which can then be compared to the existing data in the system. In other embodiments, the communication channel is a bidirectional channel that both pulls and pushes data between the tag application 316 launched in or by the media player 202 and the backend services/retail information server 204. Examples of data that may be exchanged using push and/or pull techniques include unique identifiers for each product, price changes, description changes, characteristic updates (e.g., size of units by weight or volume or quantity per package), etc. As items or products are sold or otherwise depleted from inventory at, for example, the point of sale, a reduction in inventory may be registered via a push technique and/or pull technique described herein to transmit the inventory update information between the retail information server 204 and the media player 202.

In some embodiments, a retail environment may be a store, multiple locations (e.g., stores) of the same entity, or multiple locations of different stores of different entities. In some embodiments, the retail information server 204 includes elements needed to manage inventory as well as create tags for individual items. Alternatively, one or more of the functions relied on to manage inventory may be performed in separate devices. In some embodiments, the retail information server 204 is configured to receive requests from the tag application 316 for information used to generate images to be displayed on the one or more digital displays 208 as shelf tags. The requests may be generated by the mobile devices 210 or, if present, by the backend services.

In some embodiments, the tag application 316 running on the media player 202 is connected with the retail information server 204 and the latest version of data provisioned (e.g., by the one or more mobile devices 210) for the digital display 208 can be provided.

In some embodiments, the communication network 206 is a network configured to establish communication between each of the information display devices 208 of the system 200. In some embodiments, the communication network 206 is a wired network, a wireless network, or combination thereof. In some embodiments, the communication network 206 includes one or more devices or elements configured to facilitate the exchange of information such as routers, switches, hubs, bridges, cables, wireless media, repeaters, gateways, firewalls, access points, etc.

In addition, the communication network 206 can be a personal area network, a local area network, a wide area network, a cable network, a satellite network, a cellular telephone network, or a combination thereof. In an exemplary embodiment, the communication network 206 can be a publicly accessible network of linked networks, possibly operated by various distinct parties, such as the Internet. In some embodiments, the communication network 206 can be a private or semi-private network, such as a corporate or university intranet.

For example, the communication network 206 can include one or more wireless networks such as a Global System for Mobile Communications (GSM) network, a Code Division Multiple Access (CDMA) network, a Long-Term Evolution (LTE) network, a WI-FI network or some other type or combination of wireless networks. Protocols and components for communicating via the Internet or any of the other aforementioned types of communication networks are well known to those skilled in the art of computer communications and thus, need not be described in more detail.

In some embodiments, the one or more digital displays 208 are configured to receive visual tag content rendered by the media player 202, and to display the visual tag content, including the retail information on the respective one or more screens of the one or more digital displays 208. While FIG. 1 illustrates one digital display 104, a plurality (e.g., two, three, four, five, tens, etc.) of digital displays can be used in a system.

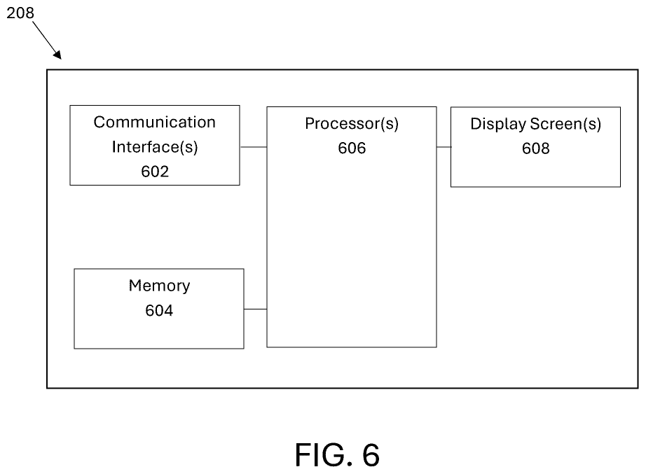

As illustrated in FIG. 6, in some embodiments, the digital display 208 includes at least one wired and/or wireless communication interface 602, at least one memory 604, one or more processors 606 associated with the communication interface 602 and the memory 604, and at least one display screen 608 also associated with the one or more processors 606. In some embodiments, the one or more digital displays 208 are one or more light emitting diode (LED) displays, one or more liquid crystal display (LCD), one or more Organic Light Emitting Diode (OLED) displays, one or more active-matrix organic light-emitting diode (AMOLED) displays, one or more plasma displays, one or more electronic ink (e-ink) displays, etc., or any combination thereof.

In an embodiment illustrated in FIG. 1, the digital display 104 is provided along an edge of the shelf 102. The digital display 104 can be mounted using any mounting configuration or system to secure the digital display 104 to the edge of the shelf 102. One display 104 can be mounted on the front edge of one shelf 102, or a plurality of digital displays 104 can be mounted on (e.g., on the front edge of) a single shelf 102. Any number and/or configurations of the shelves 102 and the digital displays 104 may be provided, including those not illustrated in FIG. 1. The shelves 102 can be organized, for example, according along and at the ends of aisles within a retail environment. The shelves 102 may be permanently or removably mounted on their respective bases, which may be stationary or mobile in nature.

The tag information corresponding to the retail information may be provided as an output of the media player 202 for display on the display device(s) 208, with the display arranged in vertical or horizontal slices such that each display device 208 can identify a corresponding slice of the output to be displayed on the particular display device 208. In some embodiments, the digital displays 208 are configured as a stretch or extended display configured to slice the content to be displayed into slices either vertically (FIG. 13) or horizontally (FIG. 14) over one or more display devices 208. Each display device 208 can show one slice or multiple slices, or share a slice extended over two or more displays.

The display devices 208 may be connected to the media player 202 in a serial arrangement, a parallel arrangement, or a combination serial and parallel arrangement. For example, the digital display devices 208 may be “daisy-chained” from a first digital display device directly connected to the media player 202. The visual data from the media player 202 can be divided into slivers that are displayed on one or more of the digital display devices 208 at locations corresponding to the shelf contents. For example, when the displays 208 are connected in series, the media player 202 can be in communication with an input of a first digital display and the output of the first digital display can be in communication with an input of a second digital display. The output of the second digital display can be in communication with an input of the third display, and so on. When the digital displays 208 are connected to media player 202 in parallel, the output of the media player 202 can be connected directly to the input of one, two, three, or more, and optionally all, of the digital displays 208.

In an embodiment, both the power provided to the digital displays 208 and the digital visual signals can be chained together from one digital display 208 to the next digital display 208. Alternatively, power and the digital visual signals to the digital displays 208 can be provided separately.

In some embodiments, the media player 202 is connected to the one or more digital displays 208 through one or more wired connectors. For example, the wired connector can be a High-Definition Multimedia Interface (HDMI) cable, Universal Serial Bus Type-C (USBC), DISPLAYPORT, etc. However, any connector to facilitate communication can be used including wireless media.

In some embodiments, the media player 202 provides a digital visual signal that includes all information needed for all tags for all shelf-mounted digital displays 208 in communication with the media player 202. Alternatively, the digital visual signal can include information corresponding to less than all tags, only updated tags, or moved merchandise.

In some embodiments, the media player 202 is located or mounted in close proximity to the one or more digital displays 208 to provide ease of connection and strength and quality of signal provided from the media player 202 to the one or more digital displays 108. In some embodiments, the media player 202 is not located or mounted in close proximity to the one or more digital displays 208, in which case a suitable communication network 206, e.g., the Internet, can be used to provide communication of signals between the media player 202 and the one or more digital displays 108.

In some embodiments, the mobile devices 210 are configured to support provisioning the tag application 316 associated with the media player 202 and facilitating communication to create tags including retail information that are displayed on the one or more digital displays 208.

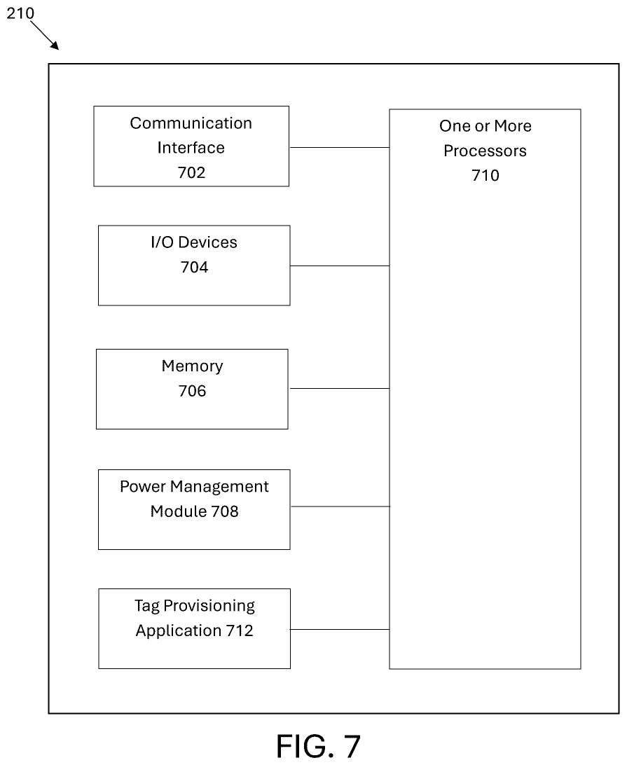

As shown in FIG. 7, in some embodiments, the mobile device 210 includes a wireless communication interface 702, I/O devices (e.g., touch screen, microphone, camera, etc.) 704, memory 706, power management module 708, and a tag provisioning application 712, each in communication with and associated with one or more processors 710.

As discussed above, in some embodiments the tag application 316 runs on the media player 202. In some embodiments, information for creating and configuring the content provided via the digital visual signal from the media player 202 to the digital displays 208 is not directly provided to the media player 202.

In an embodiment, all transmissions come from a backend service/server 204. Transmitted digital signals are rendered into media content, for example visual tag content, for display on the information display device(s) 208. The tag provisioning application 712 on the mobile device(s) 210 may send tag provisioning information comprises, for example, changes to the location or presentation of the retail information on the information display unit(s) 208. In an embodiment, the configuration change embodied in the tag provisioning information from the mobile device(s) 210 is sent to the backend service/server 204, which will then cause a data event to be pushed to the tag application module 316 running on the media player 202 to reflect the changes embodied in the tag provisioning information.

In an embodiment, a mobile application for provisioning the tag application is written specifically for the operating system of the mobile device 210 or is provided as a Hypertext Markup Language (HTML) web application that can run in a browser launched at the mobile device 210. A tag provisioning application 712 can be configured to enroll a new media player 202 and digital display 208 by matching a unique identifier that is set into the hardware or operating system of the media player 202, and combined together with the sliced position of the tag application to show a unique data representation in the form of text or barcode. Each digital display 208 can include both a unique identifier of the media player 202 as well as a position of each individual digital display 208 based on horizontal or vertical slices of content that are taken and sequentially ordered within the digital visual signal.

In some embodiments, the tag provisioning application 712 has the ability to add new tag data by selecting any media player 202 within the retail environment as well as digital displays 208 in communication with the selected media player 202. A location of tag information to be displayed on the digital display 208 can be selected via X coordinates which correspond to a length of one or more display screens associated with one or more of the digital displays 208 and Y coordinates which define which slice of a height of one or more display screens associated with one or more of the digital displays 208. A selection can be made to choose the type of tags created and stored on the retail information server 204, the data that a tag represents by either searching for, scanning via a barcode, or manually entering the unique identify of the item placed in the location of this digital tag.

In some embodiments, the tag provisioning application 712 can be configured to remove any tag that is currently displayed. The tag removal will dissociate the unique identifier of an item from that specific media player 202 and the tag application 316, from the specific geographic location associated with the media player 202. In addition, the tag provisioning application 712 can be configured to alter the visual or placement of an existing tag data by selecting the geographical location of the media player 202, and the position of that media player 202. Alterations can include existing x, y coordinates of the digital tag, the size, shape, animation etc. of the digital tag.

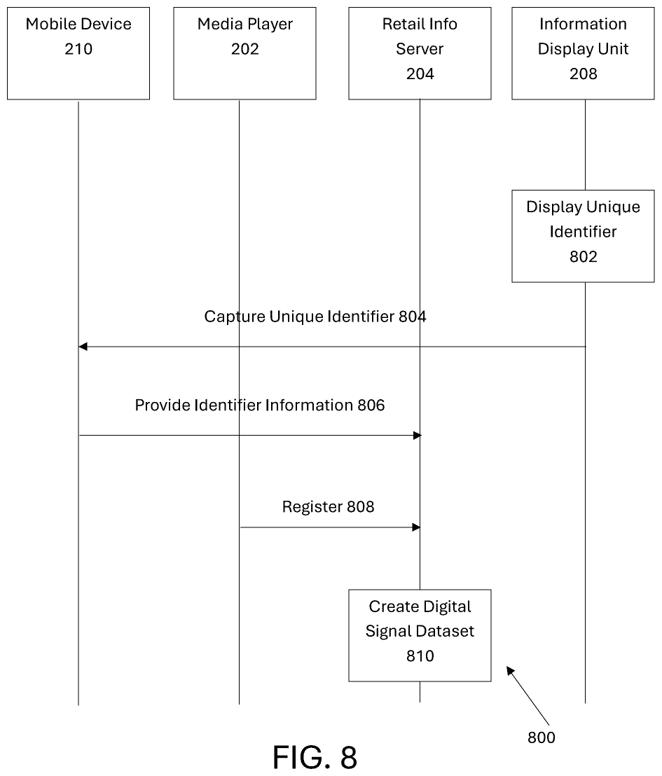

FIG. 8 illustrates a signal diagram of an initialization method of a shelf-edge system according to an exemplary embodiment of the present disclosure.

As an initial matter, prior to device initialization according to an embodiment, the one or more digital displays 208 and the media player 202 can be installed in the retail environment. For example, the one or more digital displays 208 can be mounted to one or more shelf edges as illustrated in FIG. 1. The media player 202 can be mounted in a location proximate to the shelf 102 or sufficiently proximate to transmit wireless signals to digital display(s) 104/208 mounted on the shelf 102. In some embodiments, the installation of the hardware can be done in any order and can include powering each of the media players 202 and the one or more digital displays 208. As previously discussed, the digital displays 208 can be powered through the connection with the media player 202 or can be individually powered through a power source.

According an exemplary embodiment, after the one or more digital displays 208 are powered and connected with the one or more media players 202, each of the digital displays 208 displays a unique visual identifier, as represented by 802 in FIG. 8. For example, the unique visual identifiers can be machine-readable codes such as a bar code or a quick response (QR) code. After the tag provisioning application is launched at the one or more mobile devices 210, the one or more mobile devices 210 capture the unique identifier from each of the digital displays 208 at 804 in FIG. 8. At 806 of FIG. 8, the mobile device 210 provides the unique identifier information of each of the display devices 208 to the retail information server 204.

According the exemplary embodiment of FIG. 8, the media player 202 registers with the retail information server 204 at 808. For example, the media player 202 can provide various identifying information that is unique to the media player 202. For example, the media player 202 can provide one or more of a device identifier, information corresponding to a location of the media player 202 within the retail environment (e.g., information corresponding to shelf location, aisle location, etc.), information for identifying the digital displays 208 in communication with the media player 202, and/or whether the digital displays 208 are connected in a serial or parallel configuration. The tag application 316 can be pre-installed on the media player 2022 or the tag application can be downloaded to the media player 202 upon initialization of the media player 202 with the retail information server 204.

At 810 of the exemplary embodiment of FIG. 8, the retail information server 208 creates a data set from which the digital visual signal is generated based on information associated with the media player 202 and the one or more digital displays 208. For example, the retail information server 204 can compile the information from the media player 202 and the one or more digital devices 208 and identify how to encode tag content in the digital visual signal to allow tag information to be dynamically displayed on the one or more digital displays 208.

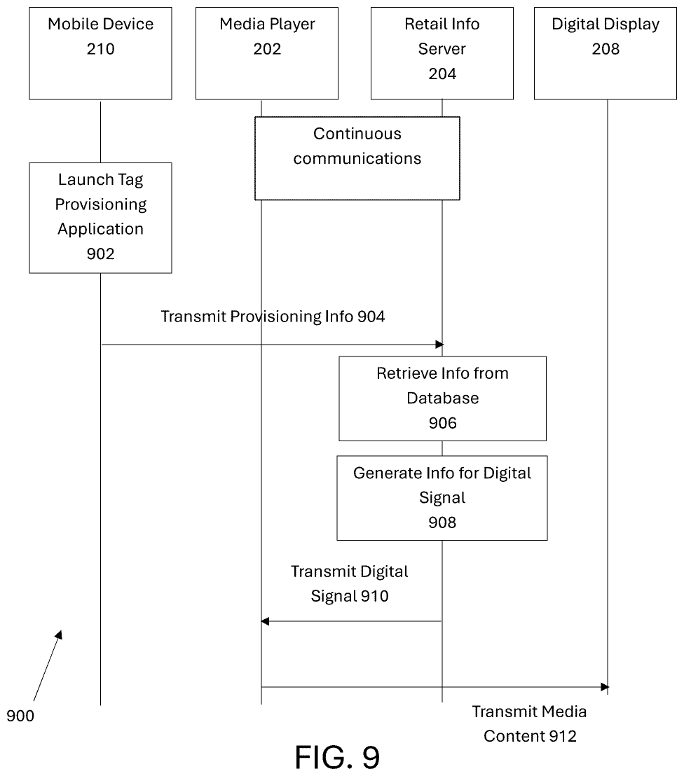

FIG. 9 illustrates a signal diagram of a tag content displaying method of the system 900 according to an exemplary embodiment of the present disclosure.

As an initial matter, communication between the media player 202 and the retail information server 204 can be continuous such that any digital visual signal can be dynamically generated in real-time whenever a change to tag content occurs, for example, whether the change occurs based on communications received from the mobile device 210 or information changed at the retail information server 204 with respect to inventory, etc. As an alternative, information exchange between the media player 202 and the retail information server 204 can be initiated using polling or other asynchronous methods.

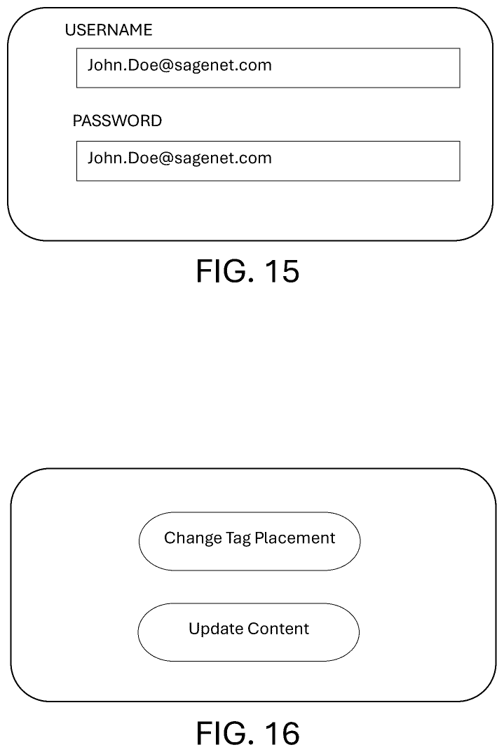

According to an embodiment illustrated in FIG. 9, at 902, the tag provisioning application 712 is launched at the mobile device 210. For example, at FIG. 15, a log-in screen is displayed which includes a request for a username and password to allow access to the tag provisioning application. In some embodiments, the user is an administrator, employer, or employee of the retail establishment.

After successfully logging into the tag provisioning application, information for provisioning tag content can be provided to the mobile device 210. In an embodiment illustrated in FIG. 16, a screen to initiate changing tag placement or updating tag content is displayed to allow the user, e.g., an administrator, to identify which parameters to provision.

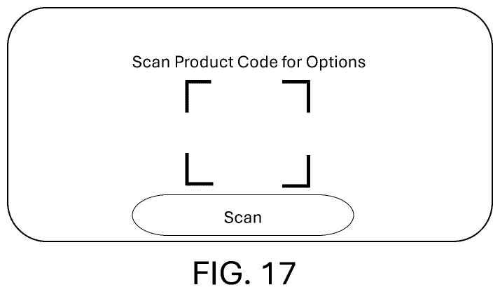

FIG. 17 illustrates a screen to capture a machine-readable code to identify inventory information associated with a specific inventory item. For example, the camera of the mobile device 210 can be used to capture a bar code or QR found on an item or its packaging, such as a box of a pair of basketball sneakers. The barcode or QR information can be transmitted from the mobile device 210 to the retail information server 204 where the information corresponding to the bar code or QR can be extracted from a database of the retail information server 204.

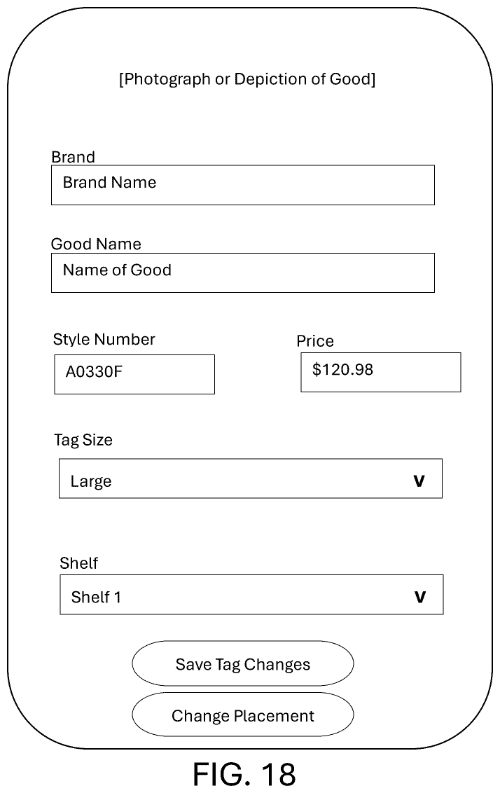

FIG. 18 illustrates a screen that includes the information provided from the retail information server based on the barcode of the specific item. Based on the inventory information retrieved from the retail information server, a user (e.g., administrator, employer, employee) can identify which parameters to include in tag content to be displayed at the one or more digital displays 208.

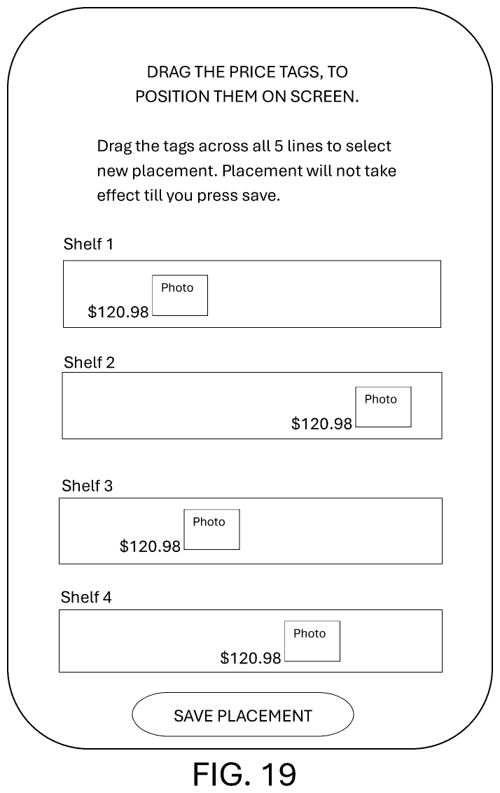

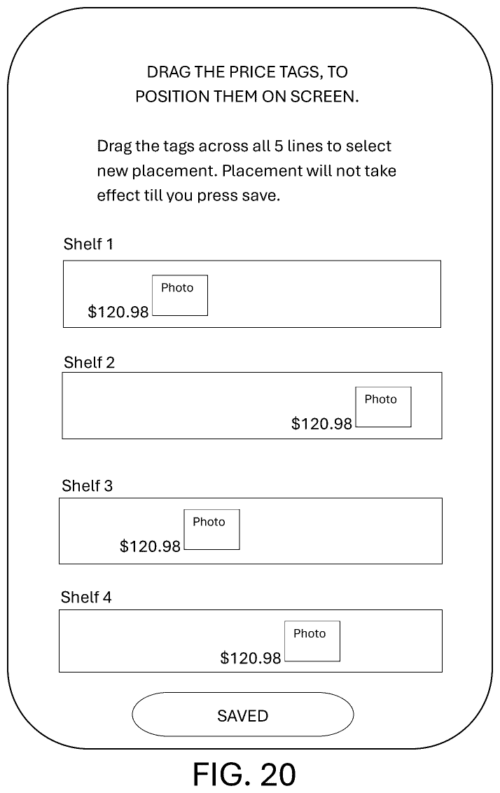

FIGS. 19 and 20 illustrate an embodiment, in particular user interfaces that allow the user to specifically identify a location where tag content is to be displayed on the digital display devices 208. In some embodiments, the user can drag and drop the tag content within a display region of a digital display unit of predetermined individual shelf locations. In an embodiment, the location of the tag on the digital display unit mounted on the front edge of a shelf can correspond to the physical location of the item on the shelf. In some embodiments, the tag content can be dynamically moved if the item is moved to a different position on the shelf so that the tag content on the display device corresponds in location to the new positioning of the item. The dynamic moveability allows for a customizable and dynamic configuration of tag information.

After all provisioning information is provided within the tag provisioning application, the provisioning information can be transmitted to the retail information server at 904. At 906, the retail information server can retrieve information and/or information is updated in the retail information database to reflect the provisioned tag content.

At 908, the retail information server generates the information for the digital visual signal including tag content for each tag identified in the tag provisioning application. At 910, the retail information server transmits the digital visual signal to the media player, and at 912 the media player transmits the rendered media content comprising tag content to the one or more digital displays, such that the tag content is displayed on the digital displays.

In an exemplary embodiment, an indication can be provided in the tag provisioning application to modify tag content for a specific tag to be visually highlighted in the display. For example, if a specific item has been identified to be included in a digital order or a customer wants to find a specific item on the shelf, tag content corresponding to the desired item can be identified in the tag provisioning application 712. The information can be transmitted to the server and an updated digital visual signal can be generated and provided to the digital display via the media player. The updated tag content can provide a visual cue to allow for identification of a specific item in a specific aisle on a specific shelf.

The exemplary systems and methods described herein can be performed under the control of a processing system including one or more processors executing computer-readable codes embodied on a non-transitory computer-readable recording medium or communication signals transmitted through a transitory medium. The non-transitory computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

Examples of mobile devices include all mobile devices known in the art, including but not limited to mobile phones, tablets, laptops, desktops, etc.

It will be understood by those with skill in the art that if a specific number of an introduced claim element is intended, such intent will be explicitly recited in the claims, and in the absence of such recitation no such limitation is present. For a non-limiting example, as an aid to understanding, the appended claims may contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to the embodiments containing only one such element, even when the same claim includes the introductory phrases “one or more” or “at least one” and indefinite articles such as “a” or “an”; the same holds true for the use in the claims of definite articles.

While particular embodiments have been shown and described, it will be understood to those skilled in the art that based upon the teachings herein, changes and modifications may be made without departing from its broader aspects. Therefore, the appended claims are to encompass within their scope all such changes and modifications as are within the true spirit and scope of the embodiments.

1. A computer system comprising:
a retail information server configured to:
receive tag provisioning information from a mobile device;
retrieve retail information associated with one or more goods based on the tag provisioning information; and
generate a digital signal based on the tag provisioning information and the retail information;
a media player configured to:
receive the digital signal; and
render, based upon the digital signal, visual tag content including the retrieved retail information; and
a digital display device positioned on a product display shelf in a retail environment and configured to receive the rendered visual tag content and to display the visual tag content at a location on the digital display device corresponding to a location of the associated one or more goods on the product display shelf.

2. The computer system of claim 1, wherein the digital display device is positioned on a front edge of the product display shelf in the retail environment.

3. The computer system of claim 1, wherein the media player comprising a tag application configured to decode and render the visual tag content that includes the retail information to be displayed on the digital display device.

4. The computer system of claim 3, wherein the tag application is configured to create a visualization for display on the digital display device, the visualization including static graphics and/or animated graphics corresponding to the retail information.

5. The computer system of claim 3, wherein the tag application is configured to generate timed or event-driven visual changes for cycling display of different retail information on the digital display device.

6. The computer system of claim 1, wherein the tag provisioning information comprises information representing positioning of the retail information on the digital display device.

7. The computer system of claim 1, wherein the tag provisioning information comprises information representing the slicing of the retail information horizontally and/or vertically.

8. A computer-implemented method for displaying tag content, the computer-implemented method comprising:
receiving, by a retail information server, tag provisioning information from a mobile device;
retrieving, by the retail information server, retail information associated with one or more goods based on the tag provisioning information;
generating, by the retail information server, a digital signal based on the tag provisioning information and the retail information;
receiving, by a media player, the digital signal;
rendering, by the media player, visual tag content including the retail information based on the digital signal;
receiving, at a digital display device positioned on a product display shelf in a retail environment, the rendered visual tag content; and
displaying, on the digital display device, the visual tag content at a location on the digital display device corresponding to a location of the associated one or more goods on the product display shelf.

9. The computer-implemented method of claim 8, wherein the digital display device is positioned on a front edge of the product display shelf in the retail environment.

10. The computer-implemented method of claim 8, wherein the media player comprising a tag application configured to decode and render the visual tag content that includes the retail information to be displayed on the digital display device.

11. The computer-implemented method of claim 10, wherein the tag application is configured to create a visualization for display on the digital display device, the visualization including static graphics and/or animated graphics corresponding to the retail information.

12. The computer-implemented method of claim 10, wherein the tag application is configured to generate timed or event-driven visual changes for cycling display of different retail information on the digital display device.

13. The computer-implemented method of claim 8, wherein the tag provisioning information comprises information representing positioning of the retail information on the digital display device.

14. The computer-implemented method of claim 8, wherein the tag provisioning information comprises information representing the slicing of the retail information horizontally and/or vertically.

15. A computer program product comprising:
a non-transitory computer-readable media; and
computer-executable instructions stored on the non-transitory computer-readable media, the computer-executable instructions executable by the processor to:
receive tag provisioning information from a mobile device;
retrieve retail information associated with one or more goods based on the tag provisioning information;
generate a digital signal based on the tag provisioning information and the retail information;
render visual tag content including the retail information based on the digital signal;
receive the rendered visual tag content at a digital display device positioned on a product display shelf in a retail environment; and
display the visual tag content at a location on the digital display device corresponding to a location of the associated one or more goods on the product display shelf.

16. The computer program product of claim 15, wherein the digital display device is positioned on a front edge of the product display shelf in the retail environment.

17. The computer program product of claim 15, wherein the computer-executable instructions further comprise a tag application executable by the processor to create a visualization for display on the digital display device, the visualization including static graphics and/or animated graphics corresponding to the retail information.

18. The computer program product of claim 15, wherein the tag application is executable by the processor to generate timed or event-driven visual changes for cycling display of different retail information display on the digital display device.

19. The computer program product of claim 15, wherein the tag provisioning information comprises information representing positioning of the retail information on the digital display device.

20. The computer program product of claim 15, wherein the tag provisioning information comprises information representing the slicing of the retail information horizontally and/or vertically.
